(19) United States
(12) Patent Application Publication
(10) Pub. No.: US 2019/0034567 A1
(43) Pub. Date: Jan. 31, 2019

(54) COMPUTER-SUPPORTED METHOD AND COMPUTER PROGRAM FOR EVALUATING THE QUALITY OF A MATERIAL STRAND

(71) Applicant: Atlas Copco IAS GmbH, Bretten (DE)

(72) Inventors: Thomas FIPPL, Westerburg (DE); Marten TOLK, Bruchsal (DE)

(73) Assignee: Atlas Copco IAS GmbH, Bretten (DE)

(21) Appl. No.: 16/075,279

(22) PCT Filed: Mar. 3, 2017
(86) PCT No.: PCT/EP2017/055012

§ 371 Date: Aug. 3, 2018

(30) Foreign Application Priority Data
Mar. 3, 2016 (DE) 10 2016 002 484.4

(51) Int. Cl. G06F 17/50; B25J 9/16; B05C 5/00; B05C 5/02

(52) U.S. Cl. CPC G06F 17/5009; B05C 5/02; B05C 5/002; B25J 9/1605

(57) ABSTRACT

A method for simulating the application of a material strand onto a workpiece, in particular a strand of a viscous adhesive or sealant, uses an application device which is moved along an application path that runs on a surface of the workpiece. Cross-section values of the material strand are assigned to application points arranged on the application path at specified distances to one another, the cross-section values characterizing the shape and size of the cross-sectional surface of the material strand, and the cross-section values are ascertained at each application point by a data processing unit from a respective specified parameter set which contains parameters that influence the material application at each application point.

The invention relates to a method, in particular computer-implemented, for simulation of the application of a material strand onto a workpiece by means of an application jig moved along an application path running on a surface of the workpiece.

Strands of viscous material, such as adhesives or sealants, for example, are usually applied industrially in automated manner on workpieces, by the fact that an application jig is moved by means of a robot along an application path running on a surface of the workpiece in question and dispenses the material onto the workpiece surface. In the process, a large number of parameters influence the shape and the size of the material strand applied on the workpiece. Worth mentioning are in particular the volume flow and the pressure with which the material is applied through an application nozzle, the distance from the nozzle to the workpiece surface, the speed of the nozzle relative to the workpiece surface, the type of material and the temperature of the material and many further parameters concerning the material, the application jig, the workpiece and the environment. In particular, during startup of the application jig, it may be difficult to adjust it such that the material application takes place in the desired way and the applied material strand satisfies the requirements. Even the change of parameters during the application process, for example a temperature change, may lead to the situation that the applied material strand is changed in undesired manner.

It is therefore the task of the invention to reduce the expense for the determination of the parameters necessary for a satisfactory material application. This task is accomplished according to the invention by a simulation method with the features of claim 1. Advantageous improvements are subject matter of the dependent claims.

The invention is based on the idea of simulating the application of a material strand, especially prior to the startup of an application jig. For this purpose, parameter sets that contain parameters that influence the cross-sectional values of the material strand are specified and saved in a data memory. The cross-sectional values of the material strand characterize its cross-sectional area in its shape and size. The parameters may be parameters characterizing the material, such as the type of the material, the viscosity or the temperature of the material, parameters of the application jig, such as the volume flow, the pressure exerted on the material, the cross section of the application nozzle, its distance from the workpiece surface or its speed relative to the workpiece surface, as well as parameters of the environment, such as the ambient temperature, for example. During the simulation of the material application, respectively one cross-sectional value that is determined from the parameter set specified at the respective application point is assigned to the application points located on the application path. Expediently, a large number of parameter sets as well as cross-sectional values determined experimentally for each parameter set are saved in a data memory. The data-processing unit, which expediently is a computer, then determines, for each parameter set, cross-sectional values assigned thereto by means of the data memory or reads them from the data memory. However, it is also possible for the data-processing unit to calculate the cross-sectional values from the specified parameter sets by means of an algorithm. In this way, a series-type arrangement of cross-sectional values, which are disposed at specified mutual distances corresponding to the series-type arrangement of the application points, is generated along the application path.

In order to obtain a simulation of the material strand between the application points also, it is preferred that the simulation of the material strand between the application points take place by interpolation, wherein cross-sectional values determined by means of interpolation are assigned by the data-processing unit to each point between the application points. It is therefore not necessary to dispose the application points too closely to one another, which would require an enormous computing power.

The application path may be a straight line, on which the application points are linearly arrayed at specified distances. For most practical cases, a straight line is a suitable simplification of a real application path, which is usually multiply curved. However, it is also possible for the application path to be an at least two-dimensional line, so that curves as well as peak and valley shapes may likewise be represented during the simulation.

A preferred embodiment provides that the cross-sectional values determined at the application points on the basis of the specified parameter sets are compared with specified target values for evaluation of the quality of the material strand. In this way, it is possible to evaluate the simulated material strand in terms of its quality and if necessary to simulate a further material strand with changed parameters, when the deviations from the target values are too large. Furthermore, it is preferred that the cross-sectional values determined by interpolation at the points between the application points are likewise compared with specified target values for evaluation of the quality of the material strand.

The invention will be explained in more detail hereinafter on the basis of an exemplary embodiment illustrated in the drawing, wherein

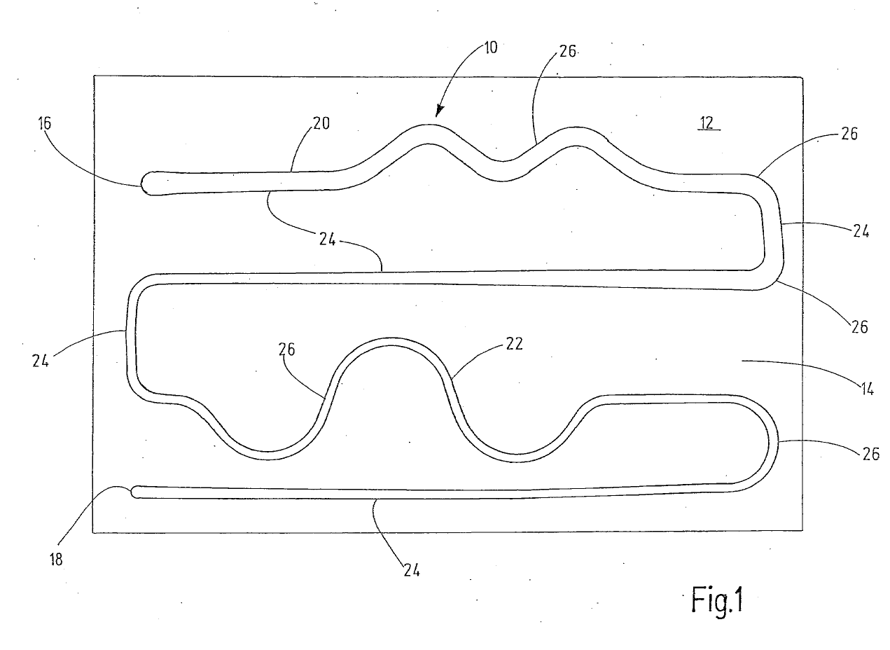

FIG. 1 shows a material strand applied on the surface of a workpiece;

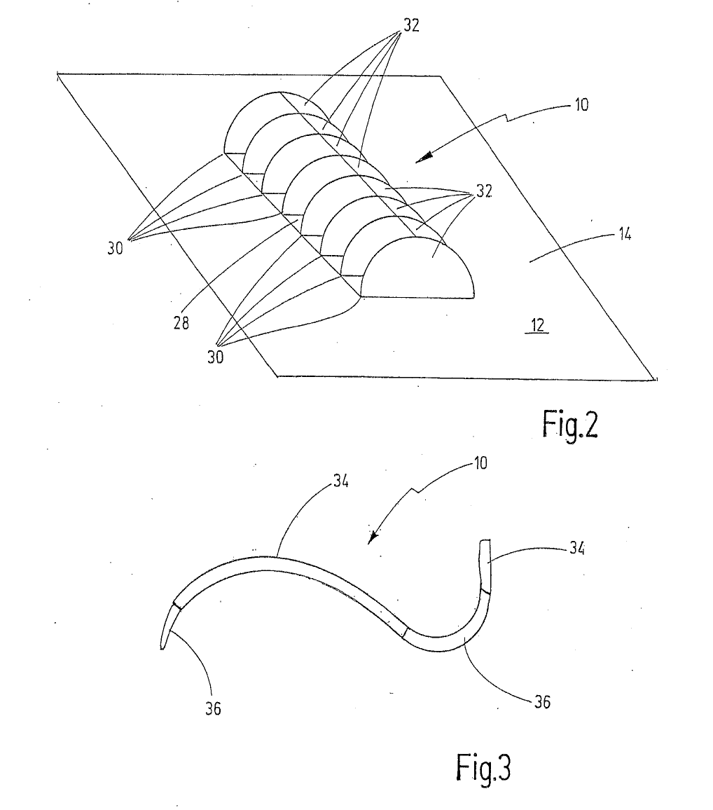

FIG. 2 shows a portion of a simulated material strand;

FIG. 3 shows a portion of a simulated material strand with identified quality of the individual sub-portions;

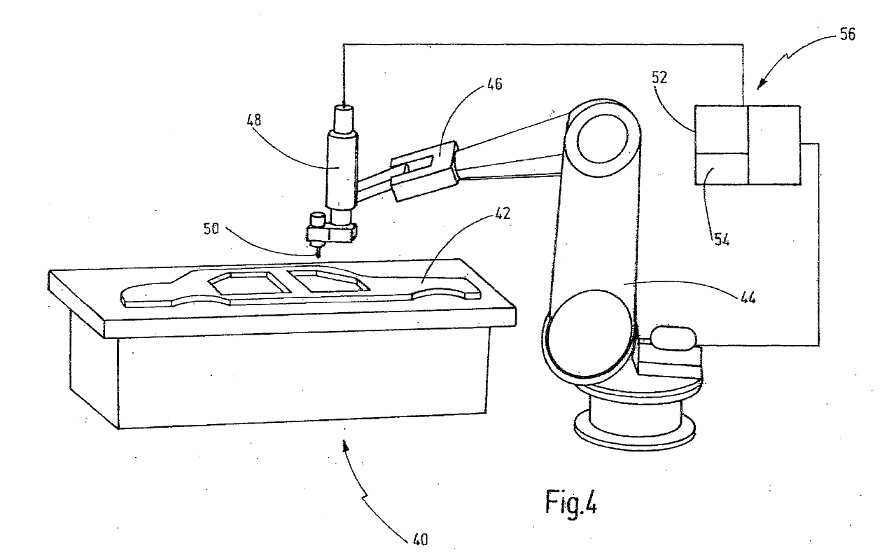

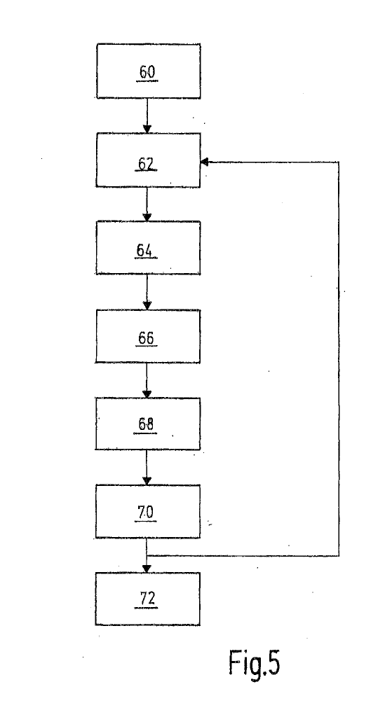

FIG. 4 shows an adhesive application jig and

FIG. 5 shows a block diagram of a simulation method.

The material strand 10, illustrated in FIG. 1, of a viscous material, especially an adhesive or a sealant, is applied on the surface 12 of a workpiece 14. The diagram according to FIG. 1 is to be seen merely as an example, but corresponds substantially to the diagram of a typical material strand. The material strand 10 begins at a starting point 16 and ends at an ending point 18. It has regions of larger cross-sectional area 20 as well as regions of smaller cross-sectional area 22, and can be subdivided into straight portions 24 and curved portions 26.

The method according to the invention permits the simulation of the application of the material strand 10 on the workpiece 14. The size and shape of the cross section of the material strand 10 is dependent on a large number of parameters at each of its points. These parameters include parameters of the application jig used for the material application, such as, for example, the volume flow or the pressure to which the material is subjected during application, the type of the nozzle from which the material emerges, in this connection especially its cross section, the speed with which the nozzle is moved relative to the workpiece 14 and its distance from the workpiece surface 12. Parameters that influence the shape and size of the strand cross section are furthermore material-specific parameters, such as the type of the material and the viscosity of the material as well as its temperature, and also environment-specific parameters such as the ambient temperature, relative humidity, etc.

The simulation is executed by a data-processing unit 52, which is provided with a data memory 54 (see FIG. 4). A large number of parameter sets, each of which contains a value for each of the above-mentioned parameters, are saved in the data memory 54. To each of these parameter sets, an experimentally determined cross-sectional value of the material strand 10 that contains the size and shape of the cross-sectional area of the material strand 10 that is achieved during material application with the parameters specified in the parameter set, is assigned and saved in the data memory 54. During the simulation according to the invention, several application points 30, which are disposed along an application path 28 on the workpiece surface 12 at specified distances from one another, are first respectively assigned a parameter set, which contains the parameters intended for the material application. Then, as shown in FIG. 2, two-dimensional representations of the strand cross section, which are read out from the data memory 54 as belonging to the parameter set specified at the application point 30 in question, are assigned to the application points 30. As illustrated in FIG. 2, the cross-sectional values 32, which can be visualized as disks, already form a good visual representation of the material strand 10 to be expected at the respective application points 30 in the case of existence of the parameter sets in question. Between the application points 30, the simulation of the material strand 10 takes place by means of interpolation, wherein cross-sectional values determined by interpolation by the data-processing unit 52 are assigned to each point between the application points 30 and in this way the intermediate spaces between the application points 30 are filled.

The representation of the material strand 10 obtained by the simulation may be compared with target values, as shown in FIG. 3. It is therefore possible to check whether the parameter sets selected during the application process are suitable for producing a material strand 10 of the desired shape. In this check, the cross-sectional values 32 achieved by the simulation are compared with target values and the material strand 10 is subdivided in its visualization into portions 34, in which it does not deviate or does so in still tolerable manner from the target values, as well as into further portions 36, in which its deviation from the target value is not tolerable. In the visualization, the portions 34, 36 may be highlighted in colored manner. Then the simulation may be repeated by changing the parameter sets for the further portions 36. If a material strand 10 that appears acceptable for use is obtained during the simulation, the specified parameter sets used during the simulation may be used during application of the actual material strand 10.

An application jig 40 for the application of adhesive on a body part 42 for a motor vehicle according to FIG. 4 is provided with a robot 44, on the robot arm 46 of which an application device 48 for the adhesive is mounted. The application device 48 is provided with an application nozzle 50, which is moved by the robot 44 along an application path at a distance from the workpiece 42 over its surface. Adhesive forced out of the application nozzle 50 by pressure is applied on the workpiece 42. The movement of the robot 44 and thus of the application device 48 relative to the workpiece 42 is controlled by means of a robot control unit, which together with an application control unit controlling the material application is part of a control device 56. It will be understood as self-evident that, besides the movement of the application device 48, a movement of the workpiece 42 is also possible, wherein for the invention it is relevant merely that the application device 48 and the workpiece 42 are moved relative to one another. In addition, the control device 56 is provided with the data-processing unit 52, which supplies the parameters determined previously during the simulation for control of the adhesive application.

In FIG. 5, the simulation method is illustrated as a block diagram. In this connection, method step 60 relates to the definition of the application points 30 on the application path 28, process step 62 relates to the readout of parameter sets and their assignment to the application points 30. Method step 64 relates to the readout of representations of the strand cross section belonging to the parameter sets, while method step 66 relates to the assignment of these representations to the application points 30. The optional method step 68 relates to the interpolation between the application points 30, method step 70 relates to the comparison of the strand cross sections assigned to the application points 30 with target values. If all strand cross sections lie within tolerance ranges around the target values, a communication of the parameter sets to the application jig 40 takes place in method step 72. If individual or all strand cross sections deviate too much from the respective target value, method step 62 is repeated, wherein individual parameters of the parameter sets that have produced too badly deviating strand cross sections are changed.

In summary, the following can be asserted: The invention relates to a method for simulation of the application of a material strand 10 onto a workpiece 14, especially a strand of viscous adhesive or sealant, by means of an application jig moved along an application path 28 running on a surface 12 of the workpiece 14, wherein cross-sectional values 32 of the material strand 10 that characterize the cross-sectional area of the material strand 10 in terms of its shape and size are assigned to application points 30 disposed at specified mutual distances on the application path 28, and wherein the cross-sectional values 32 at each application point 30 are respectively determined by means of a data-processing unit 52 from a specified parameter set, which contains parameters that influence the material application at the respective application point 30.

1. A method for simulation of the application of a material strand (10) onto a workpiece (14, 42), especially a strand of viscous adhesive or sealant, by means of an application jig moved along an application path 28 running on a surface (12) of the workpiece (14, 42), wherein cross-sectional values (32) of the material strand (10) that characterize the cross-sectional area of the material strand (10) in terms of its shape and size are assigned to application points (30) disposed at specified mutual distances on the application path (28), and wherein the cross-sectional values (32) at each application point (30) are respectively determined by means of a data-processing unit (52) from a specified parameter set, which contains parameters that influence the material application at the respective application point (30), wherein the cross-sectional values (32) determined at the application points (30) from the specified parameter sets are compared with specified target values for evaluation of the quality of the material strand (10).

2. The method according to claim 1, wherein the simulation of the material strand (10) takes place by interpolation between the application points (30), wherein cross-sectional values determined by means of interpolation are assigned by the data-processing unit (52) to each point between the application points (30).

3. The method according to claim 1, wherein a large number of parameter sets as well as cross-sectional values (32) determined experimentally for each parameter set are saved in a data memory, (54) and for each specified parameter set the data-processing unit (52) reads out the cross-sectional values (32) assigned to it from the data memory (54).

4. The method according to claim 1, wherein the data-processing unit (52) calculates the cross-sectional values (32) from the specified parameter sets by means of an algorithm.

5. The method according to claim 1, wherein the application path (28) is a straight line and the application points (30) are linearly arrayed at specified distances from one another.

6. The method according to claim 1, wherein the application path (28) is an at least two-dimensional line.

7. (canceled)

8. The method according claim 2, wherein the cross-sectional values determined by interpolation at the points between the application points (30) are compared with specified target values for evaluation of the quality of the material strand (10).

9. The method according to claim 8, wherein the material strand (10) is subdivided into portions (34), in which it does not deviate or does so in still tolerable manner from the target values, and further portions (36), in which its deviation from the target values is not tolerable.

10. The method according to claim 9, wherein the simulation is repeated, wherein the parameter sets for the further portions (36) are changed.

11. A computer program with program code for execution of all method steps according to claim 1, when the computer program is loaded in a computer (52) and is run in a computer (52).

12. A jig for application of a viscous material onto a workpiece (14, 42) with an application device (48) provided with an application nozzle (50) and movable relative to the workpiece (14, 42), and with a control device (56) for control of the material application, wherein the control device (56) is provided with a computer (52), in which a computer program according to claim 11 is loaded.
